(19) United States
(12) Patent Application Publication
(10) Pub. No.: US 2024/0309476 A1
(43) Pub. Date: Sep. 19, 2024

(54) PROCESS AND A SYSTEM FOR THE PRODUCTION OF SPONGE IRON FROM IRON ORE

(71) Applicant: HYBRIT Development AB, Stockholm (SE)

(72) Inventors: Raimon Perea Marin, Handen (SE); Farzad Mohseni-Mörner, Spânga (SE); Javad Fayazi, Solna (SE)

(21) Appl. No.: 18/571,212

(22) PCT Filed: Jun. 20, 2022
(86) PCT No.: PCT/SE2022/050606

§ 371 Date: Dec. 16, 2023

(30) Foreign Application Priority Data
Jun. 22, 2021 (SE) 2150803-1

(51) Int. Cl. C21B 13/00; C21B 13/02

(52) U.S. Cl. CPC C21B 13/0073; C21B 13/02; C21B 2100/26; C21B 2100/44; C21B 2100/66

(57) ABSTRACT

A system for the production of sponge iron, including a direct reduction shaft, a reduction gas source, a reduction gas container, a primary circuit for conducting at least a part of a top gas therethrough, a secondary circuit for conducting at least a portion of gas removed from gas conducted through the primary circuit, said secondary circuit being connected in one end to the primary circuit and in another end to the reduction gas container, a second gas line connecting the reduction gas source with the reduction gas container, and a third gas line connecting the reduction gas container with the first gas line. The system also includes a control unit configured to control a flow of reduction gas from reduction gas source to the first gas line and to control a flow of reduction gas from the reduction gas container to the first gas line through the third gas line, wherein the control unit is configured to enable a flow of reduction gas from the reduction gas container to said first gas line while correspondingly reducing a flow rate of reduction gas from the reduction gas source to said first gas line.

### TECHNICAL FIELD

The present disclosure relates to a process for the production of sponge iron from iron ore. The disclosure further relates to a system for the production of sponge iron.

### BACKGROUND ART

Steel is the worlds most important engineering and construction material. It is difficult to find any object in the modern world that does not contain steel, or depend on steel for its manufacture and/or transport. In this manner, steel is intricately involved in almost every aspect of our modern lives.

In 2018, the total global production of crude steel was 1 810 million tonnes, by far exceeding any other metal, and is expected to reach 2 800 million tonnes in 2050 of which 50% is expected to originate from virgin iron sources. Steel is also the world's most recycled material with a very high recycling grade due to the metals' ability to be used over and over again after remelting, using electricity as the primary energy source.

Thus, steel is a cornerstone of modern society with an even more significant role to play in the future.

Steel is mainly produced via three routes:
i) Integrated production using virgin iron ores in a blast furnace (BF), where iron oxide in the ore is reduced by carbon to produce iron. The iron is further processed in the steel plant by oxygen blowing in a basic oxygen furnace (BOF), followed by refining to produce steel. This process is commonly also referred to as ‘oxygen steelmaking’.
ii) Scrap-based production using recycled steel, which is melted in an electric arc furnace (EAF) using electricity as the primary source of energy. This process is commonly also referred to as ‘electric steelmaking’.
iii) Direct reduction production based on virgin iron ore, which is reduced in a direct reduction (DR) process with a carbonaceous reduction gas to produce sponge iron. The sponge iron is subsequently melted together with scrap in an EAF to produce steel.

The term crude iron is used herein to denote all irons produced for further processing to steel, regardless of whether they are obtained from a blast furnace (i.e., pig iron), or a direct reduction shaft (i.e., sponge iron).

Although the above-named processes have been refined over decades and are approaching the theoretical minimum energy consumption, there is one fundamental issue not yet resolved. Reduction of iron ore using carbonaceous reductants results in the production of CO₂ as a by-product. For every ton steel produced in 2018, an average of 1.83 tonnes of CO₂ were produced. The steel industry is one of the highest CO₂-emitting industries, accounting for approximately 7% of CO₂ emissions globally. Excessive CO₂-generation cannot be avoided within the steel production process as long as carbonaceous reductants are used.

The HYBRIT initiative has been founded to address this issue. HYBRIT, short for HYdrogen BReakthrough Ironmaking Technology □ is a joint venture between SSAB, LKAB and Vattenfall, funded in part by the Swedish Energy Agency, and aims to reduce CO₂ emissions and de-carbonize the steel industry.

Central to the HYBRIT concept is a direct reduction-based production of sponge iron from virgin iron ore. However, instead of using carbonaceous reductant gases, such as natural gas, as in present commercial direct reduction processes, HYBRIT proposes using hydrogen gas as the reductant, termed hydrogen direct reduction (H-DR). The hydrogen gas may be produced by electrolysis of water using mainly fossil-free and/or renewable primary energy sources, as is the case for e.g. Swedish electricity production. Thus, the critical step of reducing the iron ore may be achieved without requiring fossil fuel as an input, and with water as a by-product instead of CO₂.

Prior art uses reduction gas which to a large degree consists of natural gas. A direct reduction plant normally comprises a shaft in which the reduction takes place. The shaft has an inlet at the top, where iron ore pellets are introduced and an outlet at the bottom, where sponge iron is removed from shaft. There is also at least one inlet at a lower part of the shaft for introduction of a reduction gas into the shaft, and at least one outlet at an upper part of the shaft for the exit of a top gas. A large part of the top gas will consist of unreacted reduction gas, possibly mixed up with inert gas used for the sealing of the inlets and outlets for the iron ore pellets and the sponge iron respectively. A conventional way of handling the top gas is by flaring the latter.

However, when predominantly or only using hydrogen as a reduction gas, flaring is a less attractive option from an energy efficiency point of view, since, compared to natural gas, the production of hydrogen gas requires substantial amounts of energy. Furthermore, if the top gas comprises nitrogen gas (normally used as a sealing gas), the flaring may also result in the emission of NOx, which is not preferred from an environmental point of view.

The production of hydrogen gas, typically by means of water electrolysers, requires considerable amounts of electric power. Depending on what source is used for generating the electric power, the availability of the electric power may fluctuate over time. An energy-efficient and cost-efficient control of the reduction process thus also includes an optimisation of the process with regard to the availability of electric power.

It is therefore an object of the present invention to present a process and a system for the direct reduction of iron ore to sponge iron that predominantly or exclusively uses hydrogen gas as the reduction gas, wherein there is provided means for controlling a pressure in a direction reduction shaft by means of efficient recycling of unreacted hydrogen gas exiting the direct reduction shaft as part of a top gas.

It is also an object of the present invention to present a process and a system that enables an energy-efficient and cost-efficient control of the reduction process thus also includes an optimisation of the process with regard to the availability of electric power.

### SUMMARY OF THE INVENTION

The object of the invention is achieved by means of a process for the production of sponge iron from iron ore, the process comprising the steps:
charging iron ore into a direct reduction shaft;
introducing, via a first gas line, a hydrogen-rich reduction gas from a reduction gas source into the direct reduction shaft in order to reduce the iron ore and produce sponge iron;
removing a top gas from the direct reduction shaft, said top gas comprising unreacted hydrogen gas;
conducting in a primary circuit at least a part of the removed top gas and reintroducing said part of the top gas into the direct reduction shaft;
removing from said primary circuit a portion of the gas conducted therein, and conducting said portion of gas through a secondary circuit to a reduction gas container;
conducting reduction gas from the reduction gas source to said reduction gas container, to form a gas mixture therein together with the gas from the secondary circuit, and;
conducting the gas mixture from the reduction gas container to said first gas line and correspondingly reducing a flow rate of reduction gas from the reduction gas source to said first gas line.

The reduction gas container may be of considerable volume. According to one embodiment, the reduction gas container comprises a lined rock cavern.

According to one embodiment, the step of conducting the gas mixture from the reduction gas container to said first gas line is performed as a response to the gas pressure in the reduction gas container being above a predetermined level.

According to one embodiment, the reduction gas source comprises an electrolyser driven by electric power, to which there is associated a fluctuating access-related parameter, wherein the process comprises the step of continually registering the fluctuation of said access-related parameter and the step of conducting the gas mixture from the reduction gas container to said first gas line as a response to the access-related parameter being below a predetermined first level.

According to one embodiment, the access-related parameter comprises any of a level of stored electric power in an electric power storage, an access-level of a means for generating the electric power, such as solar power, wind power or hydro power. In times of reduced access to the electric power, for example during night in the case of solar power, reduction gas is thus taken from the reduction gas container instead of from the reduction gas source and delivered via the first gas line into the shaft.

According to one embodiment, the reduction gas source comprises an electrolyser driven by electric power provided via a public electric network, and wherein the process comprises the step of conducting the gas mixture from the reduction gas container to said gas line as a response to the load on the public network being above a predetermined level.

According to one embodiment, reduction gas is conducted from the reduction gas source to the reduction gas container as a response to the access-related parameter being above a predetermined second level.

According to one embodiment, said removal of said gas portion from the primary circuit to the secondary circuit is performed as a response to a pressure in the primary circuit being above a predetermined level.

According to one embodiment, gas delivered via the secondary circuit and reduction gas delivered from the reduction gas source toward the reduction gas container is compressed in a compressor step before entering the reduction gas container. The pressure in the reduction gas container may be at a considerably higher level than the pressure in the rest of the system. For example, the pressure in the direct reduction shaft may be in the order or 10 bar, while the pressure in the reduction gas container may be in the order of 100 bar.

The object of the invention is also achieved by means of a system for the production of sponge iron, the system comprising:
a direct reduction shaft comprising
a first inlet for introduction of iron ore into the shaft;
a first outlet for removal of sponge iron from the shaft;
a second inlet for introduction of a reduction gas into the shaft, and
a second outlet for removal of top gas from the shaft;
a reduction gas source, connected through a gas line with the reduction gas inlet;
a reduction gas container;
a primary circuit for conducting at least a part of the top gas through it, said primary circuit being connected in one end with the second outlet and in another end with said first gas line;
a secondary circuit for conducting at least a portion of gas removed from gas conducted through the primary circuit, said secondary circuit being connected in one end to the primary circuit and in another end to the reduction gas container;
a second gas line connecting the reduction gas source with the reduction container;
a third gas line connecting the reduction gas container with the first gas line; and
a control unit configured to control a flow of reduction gas from reduction gas source to the first gas line and to control a flow of reduction gas from the reduction gas container to the first gas line through the third gas line, wherein the control unit is configured to enable a flow of reduction gas from the reduction gas container to said first gas line while correspondingly reducing a flow rate of reduction gas from the reduction gas source to said first gas line

According to one embodiment, the system comprises means for enabling a flow of reduction gas from the reduction gas container to the first gas line as a response to the gas pressure in the reduction gas container being above a predetermined level. According to one embodiment, there is provided a pressure reducer in the third gas line. According to one embodiment, said predetermined pressure in the reduction gas container, which triggers a gas flow in the third gas line, is substantially higher than the pressure in the first gas line. The pressure reducer is configured (for example by being equipped with a turbine), to transform the higher energy of the gas passing it into electric power, which is preferably used for producing hydrogen gas in the reduction gas source.

According to one embodiment, the reduction gas source comprises an electrolyser driven by electric power, to which there is associated a fluctuating access-related parameter, and wherein the system comprises means for continually registering the fluctuation of said access-related parameter and that the control unit is configured to enable a flow of reduction gas from the reduction gas container to said gas line as a response to the access-related parameter being below a predetermined first level.

According to one embodiment, the access-related parameter comprises any of a level of stored electric power in an electric power storage or an access-level of a means for generating the electric power, such as solar power, wind power or hydro power.

According to one embodiment, the reduction gas source comprises an electrolyser driven by electric power provided via a public electric network, wherein the system comprises means for registering a load on the public electric network, and wherein the control unit is configured to enable a flow of the gas mixture from the reduction gas container to said gas line as a response to the load on the public network being above a predetermined level. Thus, when the load on the public network is high, and the price of electric power is high as a consequence thereof, reduction gas to the reduction shaft is increasingly taken from the reduction gas container instead of from the reduction gas source, in particular when the latter comprises an electrolyser.

According to one embodiment, the control unit is configured to reduce an output of the reduction gas source as a response to the enablement of a reduction gas flow from the reduction gas container to the first gas line under the condition that a requested reduction gas flow in the first gas line is achieved.

According to one embodiment, the control unit is configured to enable a flow of reduction gas from the reduction gas source to the reduction gas container as a response to the access-related parameter being above a predetermined second level. When the access to the electric power enables the reduction gas source to produce reduction gas at a higher rate than is required to the shaft, the control unit controls the production and delivery of reduction gas such that excessive reduction gas produced by the reduction gas source is delivered to the reduction gas container. A compressor is preferably arranged in the second gas line in order to generate a high pressure in the reduction gas container.

According to one embodiment, the system comprises means configured to enable said removal of said gas portion from the primary circuit to the secondary circuit as a response to a pressure in the primary circuit being above a predetermined level. The system may also, or as an alternative, comprise means configured to provide for a continuous bleed-off of top gas from the primary circuit to the secondary circuit.

According to one embodiment, the system comprises a compressor arrangement for compressing said portion of gas delivered via the secondary circuit and reduction gas delivered from the reduction gas source through said second gas line before entering the reduction gas container. The compressor arrangement may comprise said compressor arranged in the second gas line.

According to one embodiment, the system comprises at least one first sensor for measuring a reduction gas flow rate in the first gas line, at least one second sensor for measuring a temperature inside the direct reduction shaft and at least one third sensor for measuring a pressure indicative of the pressure inside the direct reduction shaft, wherein the control unit is configured to determine a requested reduction gas flow rate in the first gas line and into the direct reduction shaft on basis of input received from said first, second and third sensors.

According to one embodiment, the direct reduction shaft has a nominal production rate of sponge iron per hour, and the storage capacity of the reduction gas container corresponds to the amount of hydrogen gas required for enabling reduction at said nominal reduction rate for at least one hour, preferably for at least three hours, even more preferably for at least six hours.

### BRIEF DESCRIPTION OF THE DRAWINGS

For a fuller understanding of the present invention and further objects and advantages of it, the detailed description set out below should be read together with the accompanying drawings, in which the same reference notations denote similar items in the various diagrams, and in which:

FIG. 1 schematically illustrates an iron ore-based steelmaking value chain according to the Hybrit concept; and

FIG. 2 schematically illustrates an exemplifying embodiment of a system suitable for performing a process as disclosed herein.

### DETAILED DESCRIPTION

### Definitions

Reduction gas is a gas capable of reducing iron ore to metallic iron. The reducing components in conventional direct reduction processes are typically hydrogen and carbon monoxide, but in the presently disclosed process, the reducing component is predominantly or exclusively hydrogen. The reduction gas is introduced at a point lower than the iron ore inlet of the direct reduction shaft, and flows upwards counter to the moving bed of iron ore in order to reduce the ore.

Top gas is process gas that is removed from an upper end of the direct reduction shaft, in proximity to the ore inlet. The top gas typically comprises a mixture of partially spent reduction gas, including oxidation products of the reducing component (e.g. H2O), and inert components introduced to the process gas as e.g. seal gal. After treatment, the top gas may be recycled back to the direct reduction shaft as a component of the reduction gas.

A bleed-off stream removed from spent carburization gas in order to prevent accumulation of inert components in the carburization process gas is termed the carburization bleed-off stream.

Gas from the reduction gas source may be referred to as make-up gas. In the context of this application make-up gas is added to recycled top gas prior to re-introduction into the direct reduction shaft. Thus, the reduction gas typically comprises make-up gas together with recycled top gas.

Seal gas is gas entering the direct reduction shaft from the ore charging arrangement at the inlet of the direct reduction (DR) shaft. The outlet end of the direct reduction shaft may also be sealed using a seal gas, and seal gas therefore may enter the DR shaft from a discharging arrangement at the outlet of the direct reduction shaft. The seal gas is typically an inert gas in order to avoid explosive gas mixtures being formed at the shaft inlet and outlet. Inert gas is gas that does not form potentially flammable or explosive mixtures with either air or process gas, i.e., a gas that may not act as an oxidant or fuel in a combustion reaction under the conditions prevailing in the process. The seal gas may consist essentially of nitrogen and/or carbon dioxide. Note that although carbon dioxide is termed herein as an inert gas, it may under conditions prevailing in the system react with hydrogen in a water-gas shift reaction to provide carbon monoxide and steam.

### Reduction

The direct reduction shaft may be of any kind commonly known in the art. By shaft, it is meant a solid-gas counter-current moving bed reactor, whereby a burden of iron ore is introduced at an inlet at the top of the reactor and descends by gravity towards an outlet arranged at the bottom of the reactor. Reduction gas is introduced at a point lower than the inlet of the reactor and flows upwards counter to the moving bed of ore in order to reduce the ore to metallized iron. Reduction is typically performed at temperatures of from about 900° C. to about 1100° C. The temperatures required are typically maintained by pre-heating of the process gases introduced into the reactor, for example using a preheater such as an electric preheater. Further heating of the gases may be obtained after leaving the pre-heater and prior to introduction into the reactor by exothermic partial oxidation of the gases with oxygen or air. Reduction may be performed at a pressure of from about 1 bar to about 10 bar in the DR shaft, preferably from about 3 bar to about 8 bar. The reactor may have a cooling and discharge cone arranged at the bottom to allow the sponge iron to cool prior to discharge from the outlet.

The iron ore burden typically consists predominantly of iron ore pellets, although some lump iron ore may also be introduced. The iron ore pellets typically comprise mostly hematite, together with further additives or impurities such as gangue, fluxes and binders. However, the pellets may comprise some other metals and other ores such as magnetite. Iron ore pellets specified for direct reduction processes are commercially available, and such pellets may be used in the present process. Alternatively, the pellets may be specially adapted for a hydrogen-rich reduction step, as in the present process.

The reduction gas is hydrogen-rich. By reduction gas it is meant the sum of fresh make-up gas plus recycled parts of the top gas being introduced into the direct reduction shaft. By hydrogen-rich it is meant that the reduction gas entering the direct reduction shaft may consist of greater than 70 vol % hydrogen gas, such as greater than 80 vol % hydrogen gas, or greater than 90 vol % hydrogen gas (vol % determined at normal conditions of 1 atm and 0° C.). Preferably, the reduction is performed as a discrete stage. That is to say that carburization is not performed at all, or if carburization is to be performed, it is performed separately from reduction, i.e., in a separate reactor, or in a separate discrete zone of the direct reduction shaft. This considerably simplifies treatment of the top gas, since it is avoiding the need to remove carbonaceous components, and the expense associated with such removal. In such a case, the make-up gas may consist essentially of, or consist of, hydrogen gas. Note that some quantities of carbon-containing gases may be present in the reduction gas, even if the make-up gas is exclusively hydrogen. For example, if the sponge iron outlet of the direct reduction shaft is coupled to the inlet of a carburization reactor, relatively small quantities of carbon-containing gases may inadvertently permeate into the direct reduction shaft from the carburization reactor. As another example, carbonates present in the iron ore pellets may be volatilized and manifest as CO₂ in the top gas of the DR shaft, resulting in quantities of CO₂ that may be recycled back to the DR shaft. Due to the predominance of hydrogen gas in the reduction gas circuit, any CO₂ present may be converted by reverse water-gas shift reaction to CO.

In some cases it may be desirable to obtain some degree of carburization in conjunction with performing the reduction, as a single stage. In such a case, the reduction gas may comprise up to about 30 vol % of carbon-containing gases, such as up to about 20 vol %, or up to about 10 vol % (determined at normal conditions of 1 atm and 0° C.). Suitable carbon-containing gases are disclosed bellow as carburizing gases.

The hydrogen gas may preferably be obtained at least in part by electrolysis of water. If the water electrolysis is performed using renewable energy then this allows the provision of a reduction gas from renewable sources. The electrolytic hydrogen may be conveyed by a conduit directly from the electrolyser to the DR shaft, or the hydrogen may be stored upon production and conveyed to the DR shaft as required.

The top gas upon exiting the direct reduction shaft will typically comprise unreacted hydrogen, water (the oxidation product of hydrogen), and inert gases. If carburization is performed together with reduction, the top gas may also comprise some carbonaceous components such as methane, carbon monoxide and carbon dioxide. The top gas upon exiting the direct reduction shaft may initially be subjected to conditioning, such as dedusting to remove entrained solids, and/or heat exchange to cool the top gas and heat the reduction gas. During heat exchange, water may be condensed from the top gas. Preferably, the top gas at this stage will consist essentially of hydrogen, inert gas and residual water. However, if carbonaceous components are present in the top gas, such carbonaceous components may also be removed from the top gas, for example by reforming and/or CO₂ absorption.

### Sponge Iron

The sponge iron product of the process described herein is typically referred to as direct reduced iron (DRI). Depending on the process parameters, it may be provided as hot (HDRI) or cold (CDRI). Cold DRI may also be known as Type (B) DRI. DRI may be prone to re-oxidation and in some cases is pyrophoric. However, there are a number of known means of passivating the DRI. One such passivating means commonly used to facilitate overseas transport of the product is to press the hot DRI into briquettes. Such briquettes are commonly termed hot briquetted iron (HBI), and may also be known as type (A) DRI.

The sponge iron product obtained by the process herein may be an essentially fully metallized sponge iron, i.e., a sponge iron having a degree of reduction (DoR) greater than about 90%, such as greater than about 94% or greater than about 96%. Degree of reduction is defined as the amount of oxygen removed from the iron oxide, expressed as a percentage of the initial amount of oxygen present in the iron oxide. It is often not commercially favourable to obtain sponge irons having a DoR greater than about 96% due to reaction kinetics, although such sponge irons may be produced if desired.

If carburization is performed, sponge iron having any desired carbon content may be produced by the process described herein, from about 0 to about 7 percent by weight. However, it is typically desirable for further processing that the sponge iron has a carbon content of from about 0.5 to about 5 percent carbon by weight, preferably from about 1 to about 4 percent by weight, such as about 3 percent by weight, although this may depend on the ratio of sponge iron to scrap used in a subsequent EAF processing step.

### Embodiments

The invention will now be described in more detail with reference to certain exemplifying embodiments and the drawings. However, the invention is not limited to the exemplifying embodiments discussed herein and/or shown in the drawings, but may be varied within the scope of the appended claims. Furthermore, the drawings shall not be considered drawn to scale as some features may be exaggerated in order to more clearly illustrate certain features.

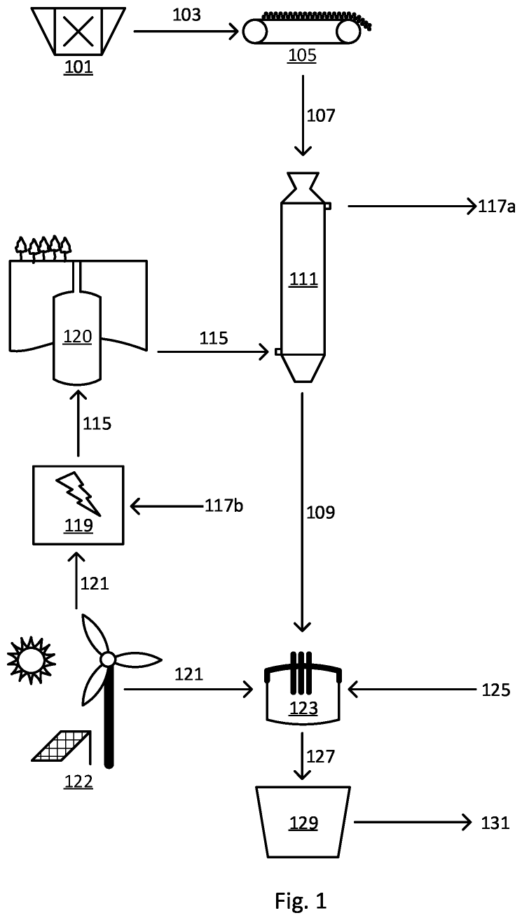

FIG. 1 schematically illustrates an iron ore-based steelmaking value chain according to the Hybrit concept. The iron ore-based steelmaking value chain starts at the iron ore mine 101. After mining, iron ore 103 is concentrated and processed in a pelletizing plant 105, and iron ore pellets 107 are produced. These pellets, together with any lump ore used in the process, are converted to sponge iron 109 by reduction in a direct reduction shaft 111 using hydrogen gas 115 as the main reductant and producing water 117a as the main by-product. The sponge iron 109 may optionally be carburized, either in the direct reduction shaft 111, or in a separate carburization reactor (not illustrated). The hydrogen gas 115 is produced by electrolysis of water 117b in an electrolyser 119 using electricity 121 that is preferably primarily derived from fossil-free or renewable sources 122. The hydrogen gas 115 may be stored in a hydrogen storage 120 prior to introduction into the direct reduction shaft 111. The sponge iron 109 is melted using an electric arc furnace 123, optionally together with a proportion of scrap iron 125 or other iron source, to provide a melt 127. The melt 127 is subjected to further downstream secondary metallurgical processes 129, and steel 131 is produced. It is intended that the entire value-chain, from ore to steel may be fossil-free and produce only low or zero carbon emissions.

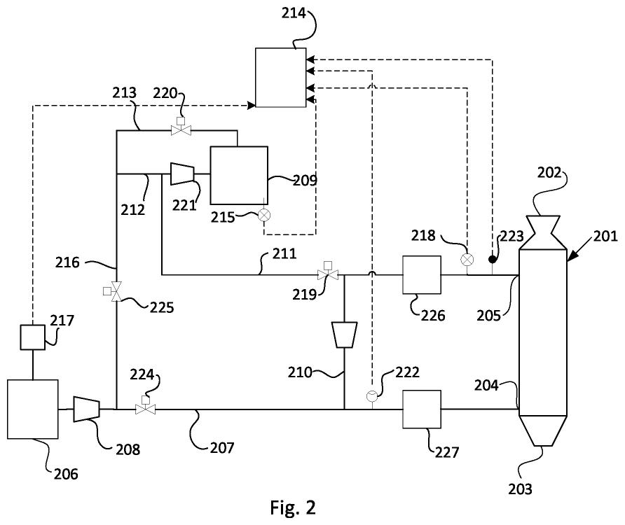

FIG. 2 schematically illustrates an exemplifying embodiment of a system suitable for performing the process as disclosed herein.

The system presented in FIG. 2 comprises a direct reduction (DR) shaft 201. The DR shaft comprises a first inlet 202 for introduction of iron ore into the DR shaft and a first outlet 203 for removal of sponge iron from the DR shaft. The DR-shaft further comprises a plurality of second inlets 204 for introduction of a reduction gas into the shaft, and at least one second outlet 205 for removal of top gas from the DR-shaft. It should be understood that the second inlets may be numerous, but that, for the sake of simplicity, only one thereof is shown in the figure.

The system further comprises a reduction gas source 206, connected through a first gas line 207 with the reduction gas inlet(s) 204. The reduction gas source may comprise a hydrogen production unit. In the presented embodiment, the reduction gas source comprises a water electrolyser unit. The reduction gas from reduction gas source 206 has a rather low pressure, in the order of 1 bar, and needs to be compressed before being introduced into the DR-shaft. Therefore, the system further comprises a first compressor 208 provided in the first gas line 207, configured to increase the pressure of the reduction gas to about 8 bar.

The system further comprises a reduction gas container 209. In the presented embodiment, the reduction gas container 209 comprises a lined rock cavern. The direct reduction shaft 201 has a nominal production rate of sponge iron per hour, and the storage capacity of the reduction gas container 209 corresponds to the amount of hydrogen gas required for enabling reduction at said nominal reduction rate for at least six hours.

The system further comprises a primary circuit 210 for conducting at least a part of the top gas through it, said primary circuit being connected in one end with the second outlet 205 and in another end with said first gas line 207.

A secondary circuit 211 is provided for conducting at least a portion of gas removed from gas conducted through the primary circuit 210. The secondary circuit 211 is connected in one end to the primary circuit 210 and in another end to the reduction gas container 209. The secondary circuit 211 is used for controlling the pressure in the primary circuit 210 and, thereby, in the DRI shaft.

The system further comprises a second gas line 212 connecting the reduction gas source 206 with the reduction gas container 209, and a third gas line 213 connecting the reduction gas container 209 with the first gas line 207. In the embodiment shown in FIG. 2, the second gas line 212 is connected to the reduction gas source 206 via the first gas line 207 and a fourth gas line 216 extending from the first gas line to said second gas line 212. The third gas line 213 is connected to the first gas line 207 via said fourth gas line 216. The fourth gas line 216 is connected to the first gas line 207 downstream said first compressor 208. Alternative embodiments, in which the fourth gas line is excluded, and in which the second gas line 212 is and the third gas line 213 do not share a common gas to be connected to the first gas line are, but extend separately to the latter, are also feasible.

A control unit 214 is configured to control a flow of reduction gas from the reduction gas source 206 through the first gas line 207 by control of an operable valve 224 arranged in the first gas line 207. The control unit 214 is also configured to control a flow of reduction gas from the reduction gas container 209 to the first gas line 207 through the third gas line 213 by control of an operable valve 220 provided in the third gas line 213. The control unit 214 is configured to enable a flow of reduction gas from the reduction gas container 209 to said first gas line 207 while correspondingly reducing a flow rate of reduction gas from the reduction gas source 206 to said first gas line 207. The control unit 214 is also configured to control the flow of reduction gas to the second gas line 212 by controlling an operable valve 225 provided in the fourth gas line 212. The operable valve 225 in the fourth gas line 216 is also used for controlling the gas flow from the reduction gas container 209 to the first gas line 207. Preferably, each of said controllable valves is a proportional valve by means of which the flow rate and pressure in the respective gas line may be controlled.

The system comprises means for enabling a flow of reduction gas from the reduction gas container 209 to the first gas line 207 as a response to the gas pressure in the reduction gas container 209 being above a predetermined level. Said means comprises a pressure sensor 215 provided in the third gas line and the operable control valve 220 provided in the third gas line 213 and controlled by the control unit 214. There may also be provided a pressure reducer, not shown, in the third gas line 213. According to one embodiment, said predetermined pressure in the reduction gas container 209, which triggers a gas flow in the third gas line 213, is substantially higher than the pressure in the first gas line 207. A pressure reducer, if applied, would be configured (for example by being equipped with a turbine), to transform the higher energy of the gas passing it into electric power, which is preferably used for producing hydrogen gas in the reduction gas source.

The reduction gas source 206 comprises an electrolyser driven by electric power from an electric power source 217. According to one embodiment, the power source 217 comprises a renewable energy source such as a solar energy plant or a wind energy plant. As the electric power produced by such a plant may fluctuate over time, the control unit 214 is configured to enable a flow of reduction gas from the reduction gas container 209 to said first gas line 207 as a response to the produced electric power being below a predetermined first level.

The electric power source 217 may also comprise a public electric network, wherein the system comprises means for registering a load on the public electric network. The control unit 214 may then be configured to enable a flow of the gas mixture from the reduction gas container 209 to the first gas line 207 as a response to the load on the public network, and thereby the price of the electric power, being above a predetermined level. Thus, when the load on the public network is high, and the price of electric power is high as a consequence thereof, reduction gas to the reduction shaft 201 may predominantly be delivered from the reduction gas container 209 instead of from the reduction gas source 206, in particular when the latter comprises an electrolyser.

The control unit 214 is configured to reduce an output of the reduction gas source 206 as a response to enablement of a reduction gas flow from the reduction gas container 209 to the first gas line 207 under the condition that a requested reduction gas flow in the first gas line 207 and into the DR shaft is achieved.

The control unit 214 is configured to enable a flow of reduction gas from the reduction gas source 206 to the reduction gas container 209 as a response to the access to electric power being above a predetermined second level. When the access to the electric power enables the reduction gas source 206 to produce reduction gas at a higher rate than is required to the DR shaft, the control unit 214 controls the production and delivery of reduction gas such that excessive reduction gas produced by the reduction gas source 206 is delivered to the reduction gas container 209.

The system comprises a pressure sensor 218, an operable valve 219 and the control unit 214, whereby the control unit 214 controls the valve 219 on basis of input from the sensor 218 to remove a gas portion from the primary circuit 210 to the secondary circuit 211 as a response to a pressure in the primary circuit 210 being above a predetermined level. The system may also, or as an alternative, comprise means configured to provide for a continuous bleed-off of top gas from the primary circuit 210 to the secondary circuit 211.

The system further comprises a compressor arrangement 220, 221 for compressing said portion of gas delivered via the secondary circuit 211 and reduction gas delivered from the reduction gas source 206 through said second gas line 212 before entering the reduction gas container 209.

The system comprises at least a first sensor 222 for measuring a reduction gas flow rate in the first gas line 207, at least one second sensor 223 for measuring a temperature inside or at the outlet of the direct reduction shaft 201 or a temperature indicative of the temperature in the DR shaft 201 or the outlet thereof, and at least one third sensor, here the pressure sensor 218 in the primary circuit, for measuring a pressure indicative of the pressure inside the DR shaft. The control unit 214 is configured to determine a requested reduction gas flow rate in the first gas line 207 and into the DR shaft on basis of input received from said first, second and third sensors 222, 223, 218.

The primary circuit 210 further comprises a device 226 for a treatment of the top gas, said device 226 comprising a device (not shown in detail) for separation of an inert gas from the part of the top gas that is to be conducted through the primary circuit 210. The treatment device 226 also comprises a device (not shown in detail) for separation of water and dust/particulate matter from said part of the top gas that is to be conducted through the primary circuit 210. The treatment device 226 also comprises a heat exchanger (not shown in detail) for heat exchange between the top gas and the reduction gas flowing through the gas line 207. There is also provided a separate heater 227 for the heating of the reduction gas in the first gas line 207, i.e., for the heating of the reduction gas coming from the reduction gas source 206 and/or from the reduction gas container 209 and from the primary circuit 210.

1. A process for the production of sponge iron from iron ore, the process comprising the steps of:
charging iron ore into a direct reduction shaft;
introducing, via a first gas line, a hydrogen-rich reduction gas from a reduction gas source into the direct reduction shaft in order to reduce the iron ore and produce sponge iron;
removing a top gas from the direct reduction shaft, said top gas comprising unreacted hydrogen gas;
conducting in a primary circuit at least a part of the removed top gas and reintroducing said part of the top gas into the direct reduction shaft;
removing from said primary circuit a portion of the gas conducted therein, and conducting said portion of gas through a secondary circuit to a reduction gas container;
conducting reduction gas from the reduction gas source to said reduction gas container to form a gas mixture therein together with the gas from the secondary circuit; and
conducting the gas mixture from the reduction gas container to said first gas line and correspondingly reducing a flow rate of reduction gas from the reduction gas source to said first gas line.

2. The process according to claim 1, wherein the step of conducting the gas mixture from the reduction gas container to said first gas line is a response to the gas pressure in the reduction gas container being above a predetermined level.

3. The process according to claim 1, wherein the reduction gas source comprises an electrolyser driven by electric power, to which there is associated a fluctuating access-related parameter, wherein the process further comprises the step of continually registering the fluctuation of said access-related parameter, and wherein the step of conducting the gas mixture from the reduction gas container (209) to said gas line is a response to the access-related parameter being below a predetermined first level.

4. The process according to claim 3, wherein the access-related parameter comprises any of a level of stored electric power in an electric power storage, an access-level of a means for generating the electric power, such as solar power, wind power or hydro power.

5. The process according to claim 1, wherein the reduction gas source comprises an electrolyser driven by electric power provided via a public electric network, and wherein the step of conducting the gas mixture from the reduction gas container (209) to said first gas line (207) is a response to the load on the public network being above a predetermined level.

6. The process according to claim 3, wherein reduction gas is conducted from the reduction gas source to the reduction gas container as a response to the access-related parameter being above a predetermined second level.

7. The process according to claim 1, wherein said removal of said gas portion from the primary circuit to the secondary circuit is performed as a response to a pressure in the primary circuit being above a predetermined level.

8. The process according to claim 1, wherein gas delivered via the secondary circuit and reduction gas delivered from the reduction gas source toward the reduction gas container is compressed in a compressor step before entering the reduction gas container.

9. A system for the production of sponge iron, the system comprising:
a direct reduction shaft comprising
a first inlet for introduction of iron ore into the shaft;
a first outlet for removing sponge iron from the shaft;
a second inlet for introduction of a reduction gas into the shaft, and
a second outlet for removing top gas from the shaft;
a reduction gas source connected through a first gas line with the reduction gas inlet;
a reduction gas container;
a primary circuit for conducting at least a part of the top gas therethrough, said primary circuit being connected in one end with the second outlet and in another end with said first gas line;
a secondary circuit for conducting at least a portion of gas removed from gas conducted through the primary circuit, said secondary circuit being connected in one end to the primary circuit and in another end to the reduction gas container;
a second gas line connecting the reduction gas source with the reduction gas container;
a third gas line connecting the reduction gas container with the first gas line; and
a control unit configured to control a flow of reduction gas from the reduction gas source to the first gas line and to control a flow of reduction gas from the reduction gas container to the first gas line through the third gas line, wherein the control unit is configured to enable a flow of reduction gas from the reduction gas container to said first gas line while correspondingly reducing a flow rate of reduction gas from the reduction gas source to said first gas line.

10. The system according to claim 9, wherein the system comprises means for enabling a flow of reduction gas from the reduction gas container to the first gas line in response to the gas pressure in the reduction gas container being above a predetermined level.

11. The system according to claim 9, wherein the reduction gas source comprises an electrolyser driven by electric power, to which there is associated a fluctuating access-related parameter, wherein the system further comprises means for continually registering the fluctuation of said access-related parameter, and wherein the control unit is configured to enable a flow of reduction gas from the reduction gas container to said first gas line in response to the access-related parameter being below a predetermined first level.

12. The system according to claim 11, wherein the access-related parameter comprises any of a level of stored electric power in an electric power storage or an access-level of a means for generating the electric power, such as solar power, wind power or hydro power.

13. The system according to claim 9, wherein the reduction gas source comprises an electrolyser driven by electric power provided via a public electric network, wherein the system comprises means for registering a load on the public electric network, and wherein the control unit is configured to enable a flow of the gas mixture from the reduction gas container to said gas line in response to the load on the public network being above a predetermined level.

14. The system according to claim 9, wherein the control unit is configured to reduce an output of the reduction gas source in response to enablement of a reduction gas flow from the reduction gas container to the first gas line under the condition that a requested reduction gas flow in the first gas line is achieved.

15. The system according to claim 12, wherein the control unit is configured to enable a flow of reduction gas from the reduction gas source to the reduction gas container in response to the access-related parameter being above a predetermined second level.

16. The system according to claim 9, further comprises means configured to enable said removal of said gas portion from the primary circuit to the secondary circuit as a response to a pressure in the primary circuit being above a predetermined level.

17. The system according to claim 9, wherein the system comprises a compressor arrangement for compressing said portion of gas delivered via the secondary circuit and reduction gas delivered from the reduction gas source through said second gas line before entering the reduction gas container.

18. The system according to claim 9, further comprising at least one first sensor for measuring a reduction gas flow rate in the first gas line, at least one second sensor for measuring a temperature inside the direct reduction shaft, and at least one third sensor for measuring a pressure indicative of the pressure inside the direct reduction shaft, wherein the control unit is configured to determine a requested reduction gas flow rate in the first gas line and into the direct reduction shaft on basis of received input from said first, second and third sensors.

19. The system according to claim 9, wherein the direct reduction shaft has a nominal production rate of sponge iron per hour, and wherein the storage capacity of the reduction gas container corresponds to the amount of hydrogen gas required for enabling reduction at said nominal reduction rate for at least one hour.
